(19) United States
(12) Patent Application Publication
(10) Pub. No.: US 2025/0276530 A1
(43) Pub. Date: Sep. 4, 2025

(54) LIQUID CIRCULATION DEVICE, LIQUID DISCHARGE APPARATUS, AND IMAGE FORMING APPARATUS

(71) Applicant: Takahiro YOSHIDA, Kanagawa (JP)

(72) Inventor: Takahiro YOSHIDA, Kanagawa (JP)

(21) Appl. No.: 19/066,207

(22) Filed: Feb. 28, 2025

(30) Foreign Application Priority Data
Feb. 29, 2024 (JP) 2024-030310

(51) Int. Cl. B41J 2/18; B41J 2/175; B41J 29/377

(52) U.S. Cl. CPC B41J 2/18; B41J 2/17596; B41J 29/377

(57) ABSTRACT

A liquid circulation device includes a supply tank to store a liquid and a gas in a first space, a collection tank to store the liquid and the gas in a second space, a circulation path, a liquid path, a liquid feed pump, a first gas path communicating with the first space, a first gas pump to supply gas, a second gas path communicating with the second space, a second gas pump to vacuum the gas, a gas bypass connecting the first space and the second space, and circuitry to control the liquid feed pump to flow the liquid through the liquid path at a first flow rate and control the first gas pump and the second gas pump to flow the gas from the first space to the second space through the gas bypass at a second flow rate smaller than a maximum value of the first flow rate.

### CROSS-REFERENCE TO RELATED APPLICATION

This patent application is based on and claims priority pursuant to 35 U.S.C. § 119 (a) to Japanese Patent Application No. 2024-030310, filed on Feb. 29, 2024, in the Japan Patent Office, the entire disclosure of which is hereby incorporated by reference herein.

### BACKGROUND

### Technical Field

The present disclosure relates to a liquid circulation device, a liquid discharge apparatus, and an image forming apparatus.

### Related Art

A liquid discharge apparatus including a circulation-type head as a liquid discharge head is known in the art.

### SUMMARY

The present disclosure described herein provides an improved liquid circulation device including a supply tank to store a liquid to be supplied to a head and a gas in a first space above a surface of the liquid in the supply tank, a collection tank to store the liquid collected from the head and the gas in a second space above a surface of the liquid in the collection tank, a circulation path including a first circulation path connecting the supply tank and an inlet of the head and a second circulation path connecting an outlet of the head and the collection tank to circulate the liquid through the head, a liquid path connecting the supply tank and the collection tank, a liquid feed pump to feed the liquid from the collection tank to the supply tank through the liquid path, a first gas path communicating with the first space in the supply tank, a first gas pump to supply gas to the first space through the first gas path, a second gas path communicating with the second space in the collection tank, a second gas pump to vacuum the gas from the collection tank through the second gas path, a gas bypass connecting the first space in the supply tank and the second space in the collection tank, and circuitry to control the liquid feed pump to flow the liquid through the liquid path at a first flow rate and control the first gas pump and the second gas pump to flow the gas from the first space to the second space through the gas bypass at a second flow rate smaller than a maximum value of the first flow rate.

Further, the present disclosure described herein provides an improved liquid discharge apparatus including a head to discharge a liquid, a supply tank to store the liquid and a gas, a collection tank to store the liquid and the gas, a circulation path including a first circulation path connecting the supply tank and the head and a second circulation path connecting the head and the collection tank to circulate the liquid, a liquid path connecting the supply tank and the collection tank, a liquid feed pump to feed the liquid from the collection tank to the supply tank through the liquid path, a first gas pump to supply gas to the supply tank, a second gas pump to vacuum the gas from the collection tank, and a gas bypass connecting the supply tank and the collection tank.

Further, the present disclosure described herein provides an improved image forming apparatus including a head to discharge a liquid onto a medium, a supply tank to store the liquid and a gas, a collection tank to store the liquid and the gas, a circulation path including a first circulation path connecting the supply tank and the head and a second circulation path connecting the head and the collection tank to circulate the liquid, a liquid path connecting the supply tank and the collection tank, a liquid feed pump to feed the liquid from the collection tank to the supply tank through the liquid path, a first gas pump to supply gas to the supply tank, a second gas pump to vacuum the gas from the collection tank, a gas bypass connecting the supply tank and the collection tank, and circuitry controls the liquid feed pump to flow the liquid through the liquid path at a first flow rate and controls the first gas pump and the second gas pump to flow the gas from the supply tank to the collection tank through the gas bypass at a second flow rate smaller than a maximum value of the first flow rate.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of a printer as a liquid discharge apparatus;

FIG. 2 is a plan view of a head unit of the printer of FIG. 1;

FIG. 3 is an external perspective view of a liquid discharge head;

FIG. 4 is a cross-sectional view of a liquid discharge head taken in the direction (i.e., a longitudinal direction of a liquid chamber) orthogonal to a nozzle array direction of the liquid discharge head;

FIG. 5 is a diagram illustrating the piping of a liquid circulation device;

FIG. 6 is a functional block diagram of a controller of a liquid discharge apparatus including a liquid circulation device;

FIG. 7 is a schematic diagram illustrating a configuration of a part of a liquid circulation device according to a comparative example;

FIGS. 8A and 8B are schematic diagrams each illustrating a configuration of a part of a liquid circulation device according to an embodiment of the present disclosure;

FIG. 9 is a schematic diagram illustrating another configuration of a part of a liquid circulation device;

FIG. 10 is a schematic diagram illustrating yet another configuration of a part of a liquid circulation device;

FIG. 11 is a schematic diagram illustrating still another configuration of a part of a liquid circulation device; and

FIG. 12 is a schematic diagram illustrating still yet another configuration of a part of a liquid circulation device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid circulation device, a liquid discharge apparatus, and an image forming apparatus according to embodiments of the present disclosure are described below with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

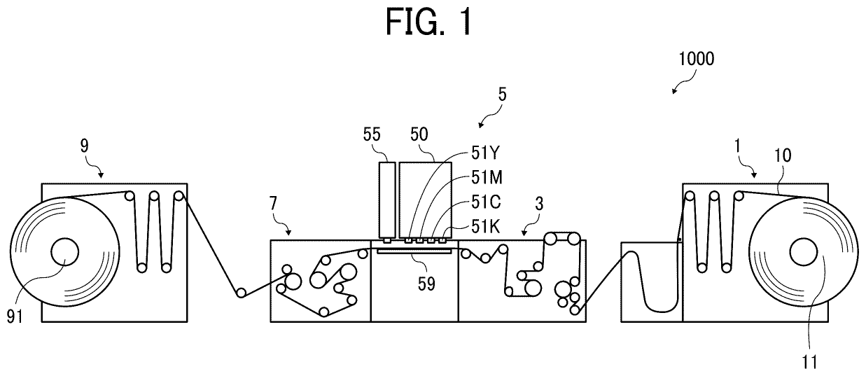

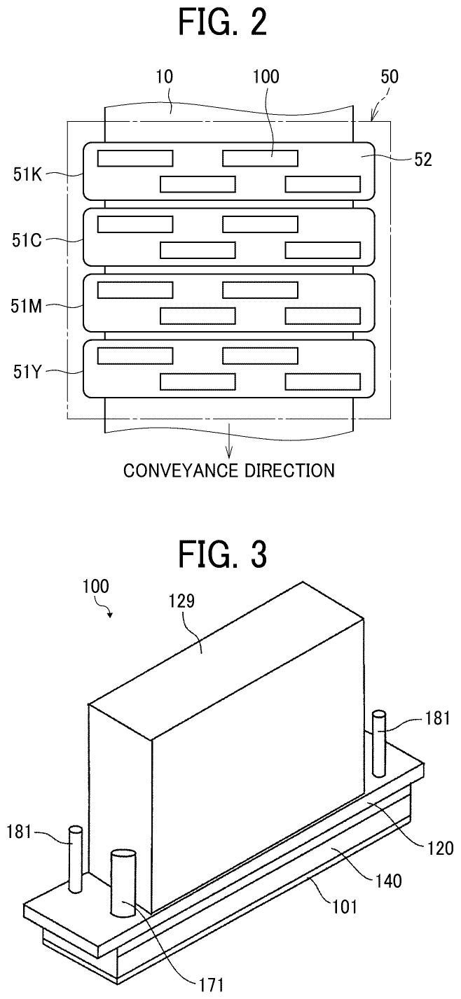

A printer as a liquid discharge apparatus will be described below with reference to FIGS. 1 to 2. The printer and the liquid discharge apparatus include a liquid circulation device which will be described later.

FIG. 1 is a schematic view of the printer. FIG. 2 is a plan view of a head unit of the printer of FIG. 1.

A printer 1000 as the liquid discharge apparatus includes a feeder 1 to feed a continuous medium 10, a guide conveyor 3 as a conveyor to guide and convey the continuous medium 10, fed from the feeder 1, to a printing device 5, the printing device 5 to discharge a liquid onto the continuous medium 10 to form an image on the continuous medium 10, a dryer 7 to dry the continuous medium 10, and a carrier 9 to feeds the dried continuous medium 10 outward. The continuous medium 10 is a discharge target or a medium onto which the discharged liquid is applied.

The continuous medium 10 is fed from a winding roller 11 of the feeder 1, guided and conveyed with rollers of the feeder 1, the guide conveyor 3, the dryer 7, and the carrier 9, and wound around a take-up roller 91 of the carrier 9.

In the printing device 5, the continuous medium 10 is conveyed on a conveyance guide 59 so as to face a head unit 50 and a head unit 55. An image is formed with liquid discharged from the head unit 50, and post-treatment is performed with treatment liquid discharged from the head unit 55.

The head unit 50 includes, for example, full-line head arrays 51K, 51C, 51M, and 51Y for four colors from the upstream side in a conveyance direction of the continuous medium 10. The full-line head arrays 51K, 51C, 51M, and 51Y may be referred to simply as the “head array 51” when colors are not distinguished.

Each of the head arrays 51 is a liquid discharge device to discharge liquid (e.g., ink) of black (K), cyan (C), magenta (M), or yellow (Y) onto the continuous medium 10 conveyed in the conveyance direction. The number and types of colors are not limited to the above-described four colors of K, C, M, and Y and may be any other suitable number and types.

In each head array 51, for example, as illustrated in FIG. 2, liquid discharge heads 100 are disposed in a staggered arrangement on a base 52 to form the head array 51. The head array 51 is not limited to such an arrangement. The liquid discharge head 100 may be referred to simply as a head 100 in the following description.

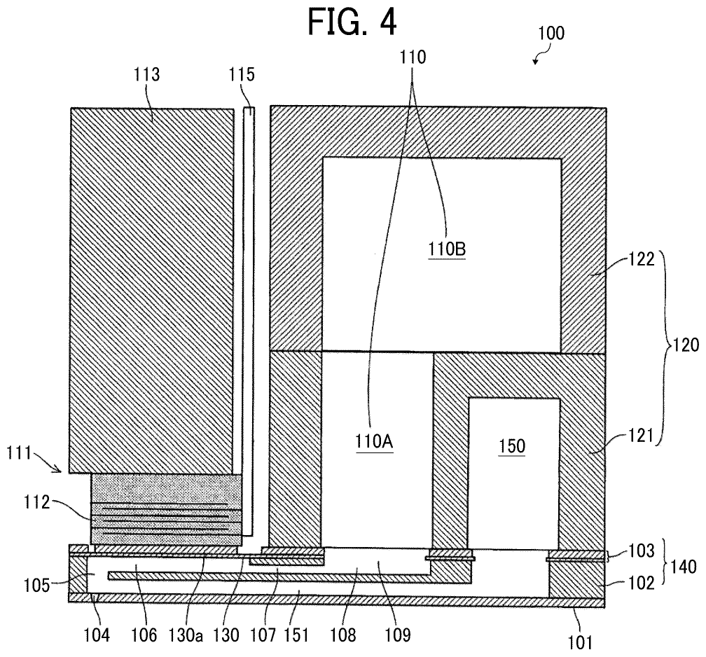

An example of the liquid discharge head is described below with reference to FIGS. 3 and 4. In the present embodiment, the liquid discharge head is a circulation-type liquid discharge head.

FIG. 3 is an external perspective view of the liquid discharge head. FIG. 4 is a cross-sectional view of the liquid discharge head of FIG. 3 in a direction (i.e., the longitudinal direction of a liquid chamber) orthogonal to a nozzle array direction.

The liquid discharge head 100 includes a nozzle plate 101, a channel plate 102, and a diaphragm substrate 103 laminated one on another and bonded to each other. The diaphragm substrate 103 serves as a wall of a liquid chamber defined by the channel plate 102. The liquid discharge head 100 further includes a piezoelectric actuator 111 to displace a vibration portion (diaphragm) 130 of the diaphragm substrate 103, a common-chamber substrate 120 that also serves as a frame of the liquid discharge head 100, and a cover 129. A portion of the head 100 constructed by the channel plate 102 and the diaphragm substrate 103 is referred to as a channel substrate 140.

The nozzle plate 101 has multiple nozzles 104, which are arranged in the nozzle array direction, to discharge a liquid.

The channel plate 102 has through holes and groves that define individual liquid chambers 106, supply-side liquid restrictors 107, and liquid inlets 108. The individual liquid chambers 106 communicate with the nozzles 104 via nozzle communication channels 105, respectively. The supply-side liquid restrictors 107 communicate with the individual liquid chambers 106, respectively. The liquid inlets 108 communicate with the supply-side liquid restrictors 107, respectively. The nozzle communication channels 105 connect the nozzles 104 and the individual liquid chambers 106, respectively. The liquid inlets 108 communicate with a supply-side common liquid chamber 110 through openings 109 of the diaphragm substrate 103.

The diaphragm substrate 103 includes the deformable vibration portion 130 serving as the wall of the individual liquid chambers 106 of the channel plate 102. In the present embodiment, the diaphragm substrate 103 has, but is not limited to, a double-layer structure and includes a first layer forming a thin portion and a second layer forming a thick portion in this order from the channel plate 102. A portion of the first layer corresponding to the individual liquid chamber 106 forms the deformable vibration portion 130.

The piezoelectric actuator 111 is disposed on one side of the diaphragm substrate 103 opposite the other side facing the individual liquid chamber 106. The piezoelectric actuator 111 includes an electromechanical transducer as a driving device (actuator device or pressure generator) to deform the vibration portion 130 of the diaphragm substrate 103.

The piezoelectric actuator 111 includes a piezoelectric element 112 bonded on a base 113. The piezoelectric element 112 is grooved by half-cut dicing to form a comb shape including a desired number of pillar-shaped elements that are arranged at certain intervals.

The piezoelectric element 112 is bonded to a projection 130a, which is an island-shaped thick portion on the vibration portion 130 of the diaphragm substrate 103. A flexible wiring board 115 is connected to the piezoelectric element 112.

The common-chamber substrate 120 defines the supply-side common liquid chamber 110 and a delivery-side common liquid chamber 150. The supply-side common liquid chamber 110 communicates with a supply port 171 (i.e., an inlet of the liquid discharge head 100), and the delivery-side common liquid chamber 150 communicates with a delivery port 181 (i.e., an outlet of the liquid discharge head 100).

The common-chamber substrate 120 includes a first common-chamber substrate 121 and a second common-chamber substrate 122. The first common-chamber substrate 121 is bonded to the diaphragm substrate 103 of the channel substrate 140. The second common-chamber substrate 122 is laminated on and bonded to the first common-chamber substrate 121.

The first common-chamber substrate 121 defines a downstream common chamber 110A and the delivery-side common liquid chamber 150. The downstream common chamber 110A is a part of the supply-side common liquid chamber 110 communicating with the liquid inlets 108. The delivery-side common liquid chamber 150 communicates with delivery channels 151. The second common-chamber substrate 122 defines an upstream common chamber 110B which is the other part of the supply-side common liquid chamber 110.

The channel plate 102 further defines the delivery channels 151 extending in the in-plane direction of the channel plate 102. The delivery channels 151 communicate with the individual liquid chambers 106 via the nozzle communication channels 105, respectively. The delivery channels 151 also communicate with the delivery-side common liquid chamber 150.

In the liquid discharge head 100, for example, the voltage to be applied to the piezoelectric element 112 is lowered from a reference potential (intermediate potential) so that the piezoelectric element 112 contracts to pull the vibration portion 130 of the diaphragm substrate 103 to increase the volume of the individual liquid chamber 106. As a result, liquid flows into the individual liquid chamber 106.

Then, the voltage to be applied to the piezoelectric element 112 is increased to expand the piezoelectric element 112 in the direction of lamination, and the vibration portion 130 of the diaphragm substrate 103 is deformed in a direction toward the nozzle 104 to reduce the volume of the individual liquid chamber 106. As a result, the liquid in the individual liquid chamber 106 is pressurized and discharged from the nozzle 104.

The liquid that has not been discharged from the nozzle 104 passes through the nozzle 104 and is delivered to the delivery-side common liquid chamber 150 through the delivery channel 151. Then, the liquid is delivered from the delivery-side common liquid chamber 150 to an external liquid circulation path (e.g., a liquid circulation device) and supplied to the supply-side common liquid chamber 110 again through the external liquid circulation path.

The method of driving the liquid discharge head is not limited to the above-described example (pull-push discharge). For example, pull discharge or push discharge may be performed in accordance with the way to apply a drive waveform.

The circulation-type liquid discharge head connected to a liquid circulation device of the present embodiment may be an individual liquid chamber type head in which liquid circulates in the vicinity of nozzles, or may be a head in which liquid circulates only in a common liquid chamber.

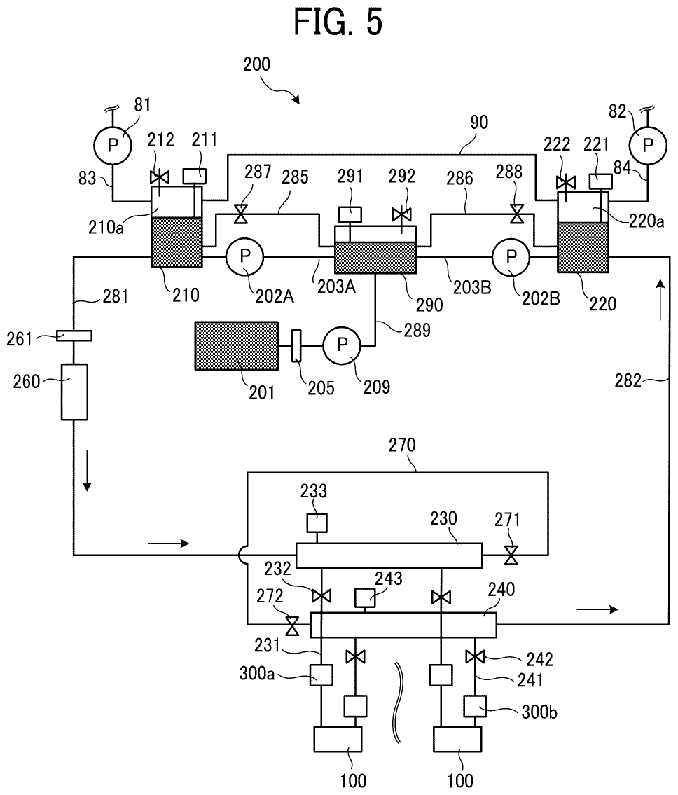

A liquid circulation device included in the liquid discharge apparatus and the printer according to the present embodiment is described below with reference to FIG. 5. FIG. 5 is a diagram illustrating the piping of the liquid circulation device. Arrows in FIG. 5 indicate the direction of flow of liquid.

The liquid circulation device of the present embodiment is connected to multiple heads 100 arranged in a line. Liquid can be circulated through the multiple heads 100. In FIG. 5, only the heads 100 at both ends in the head array 51 are illustrated.

The arrangement direction of the multiple heads 100 is preferably the same as the width direction of the discharge target (e.g., the continuous medium 10 in FIG. 1) to which the discharged liquid is applied.

A liquid circulation device 200 includes a main tank (liquid tank) 201, a supply tank 210, a collection tank 220, and a sub tank 290. The main tank 201 is a liquid storage unit that stores liquid to be discharged from the head 100. The liquid circulation device 200 further includes a first liquid feed pump 202A and a second liquid feed pump 202B, which are disposed in a liquid path, and a third liquid feed pump 209.

The liquid circulation device 200 further includes a first manifold 230 and a second manifold 240 communicating with a first head tank (pressurization head tank) 300a and a second head tank (depressurization head tank) 300b of each of multiple heads 100, and a deaerator 260 which is a degassing unit for removing dissolved gas in the liquid. The first head tank 300a and the second head tank 300b may be referred to as head tank 300 when not distinguished in the following description.

The liquid stored in the main tank 201 is fed (supplied) to the sub tank 290 by the third liquid feed pump 209 via a liquid feed path 289 including a filter 205. The sub tank 290 includes a liquid level detector 291 and a solenoid valve 292 constructing an air release mechanism for releasing air inside the sub tank 290 to the atmosphere.

The sub tank 290 and the supply tank 210 are connected to each other through a first liquid path 203A, and the first liquid feed pump 202A is disposed in the first liquid path 203A. In addition, the sub tank 290 and the supply tank 210 are connected to each other through a return liquid path 285, and a solenoid valve 287 is disposed in the return liquid path 285.

The supply tank 210 has a gas space 210a above the surface of liquid. In other words, the supply tank 210 stores both the liquid and the air. The supply tank 210 includes a liquid level detector 211 and a solenoid valve 212 constructing an air release mechanism for releasing air inside the supply tank 210 to the atmosphere.

The sub tank 290 and the collection tank 220 are connected to each other through a second liquid path 203B, and the second liquid feed pump 202B is disposed in the second liquid path 203B. In addition, the sub tank 290 and the collection tank 220 are connected to each other through a return liquid path 286, and a solenoid valve 288 is disposed in the return liquid path 286.

The collection tank 220 has a gas space 220a above the surface of liquid. In other words, the collection tank 220 stores both the liquid and the air. The collection tank 220 includes a liquid level detector 221 and a solenoid valve 222 constructing an air release mechanism for releasing air inside the collection tank 220 to the atmosphere.

The supply tank 210 is connected to the first manifold 230 through a liquid path 281 including the deaerator 260 and a filter 261. The first manifold 230 communicates with the supply port 171 of the head 100 illustrated in FIG. 3 via a supply path 231. The supply path 231 is connected to the supply port 171 of the head 100 via the first head tank 300a. The supply path 231 is provided with a solenoid valve 232 for opening and closing the path on the upstream side of the first head tank 300a. The solenoid valves 232 are provided for the heads 100, respectively, and can be individually controlled to be opened and closed. In other words, the number of the solenoid valves 232 is equal to the number of the heads 100. The first manifold 230 is provided with a pressure sensor 233.

The collection tank 220 is connected to the second manifold 240 via a liquid path 282. The second manifold 240 communicates with the delivery port 181 of the head 100 illustrated in FIG. 3 via a delivery path 241. The delivery path 241 is connected to the delivery port 181 of the head 100 via the second head tank 300b. The delivery path 241 is provided with a solenoid valve 242 for opening and closing the path on the downstream side of the second head tank 300b. The solenoid valves 242 are provided for the heads 100, respectively, and can be individually controlled to be opened and closed. In other words, the number of the solenoid valves 242 is equal to the number of the heads 100. The second manifold 240 is provided with a pressure sensor 243.

A manifold connection path 270 connects the first manifold 230 and the second manifold 240. The manifold connection path 270 is provided with a solenoid valve 271 near the first manifold 230 and a solenoid valve 272 near the second manifold 240.

Thus, a circulation path is formed by a path from the sub tank 290, via the first liquid path 203A, the supply tank 210, the liquid path 281, the deaerator 260, the first manifold 230, the head 100, the second manifold 240, the liquid path 282, the collection tank 220, and the second liquid path 203B, to the sub tank 290. In other words, the circulation path includes a supply-side circulation path (i.e., a first circulation path) connecting the supply tank 210 and the inlet (i.e., the supply port 171) of the head 100 and a collection-side circulation path (i.e., a second circulation path) connecting the outlet (i.e., the delivery port 181) of the head 100 and the collection tank 220.

The liquid path 203 (i.e., the first liquid path 203A and the second liquid path 203B) connects the supply tank 210 and the collection tank 220 via the sub tank 290. In the following description regarding the feeding of the liquid between the supply tank 210 and the collection tank 220, the sub tank 290 may be omitted.

The solenoid valves 232, 242, 271, and 272 are opened and closed to cut off the head 100 from the circulation path. The solenoid valves 232, 242, 271, and 272 switch between a first path and a second path. The first path includes the manifold connection path 270 as a part of the circulation path. The second path includes the head 100 as a part of the circulation path and cuts off the manifold connection path 270 from the circulation path.

When the solenoid valves 232 and 242 are closed and the solenoid valves 271 and 272 are opened, the circulation path includes the manifold connection path 270 and does not includes the head 100 to form the first path. On the other hand, when the solenoid valves 232 and 242 are opened and the solenoid valves 271 and 272 are closed, the circulation path includes the head 100 and does not includes the manifold connection path 270 to form the second path.

The supply tank 210, the collection tank 220, the first liquid feed pump 202A, and the second liquid feed pump 202B construct a unit for generating pressures for circulating the liquid in the circulating path.

The supply and circulation of the liquid will be described below. Liquid is fed from the main tank 201 to the sub tank 290 as follows. When the liquid level detector 291 detects a shortage of the liquid in the sub tank 290, the third liquid feed pump 209 supplies the liquid from the main tank 201 to the sub tank 290 via the liquid feed path 289 until the liquid level detector 291 detects that the liquid level is full.

Liquid is fed from the sub tank 290 to the supply tank 210 as follows. The first liquid feed pump 202A supplies the liquid from the sub tank 290 to the supply tank 210 via the first liquid path 203A.

Liquid is fed from the collection tank 220 to the sub tank 290 as follows. The second liquid feed pump 202B supplies the liquid from the collection tank 220 to the sub tank 290 via the second liquid path 203B.

Liquid is fed from the supply tank 210 to the head 100 and from the head 100 to the collection tank 220 as follows. The first liquid feed pump 202A supplies the liquid to the supply tank 210 until the pressure sensor 233 indicates a target pressure (for example, a positive pressure), and the second liquid feed pump 202B supplies the liquid to the sub tank 290 until the pressure sensor 243 indicates a target pressure (for example, a negative pressure). As a result, a pressure difference is generated between the supply tank 210 and the collection tank 220. In response to this pressure difference, the liquid can be circulated from the supply tank 210, via the liquid path 281, the filter 261, the deaerator 260, the first manifold 230, multiple supply paths 231, multiple first head tanks 300a, multiple heads 100, multiple delivery paths 241, multiple second head tanks 300b, the second manifold 240, and the liquid path 282, to the collection tank 220. At this time, the solenoid valves 232 and 242 are opened and the solenoid valves 271 and 272 are closed.

On the other hand, when the first liquid feed pump 202A and the second liquid feed pump 202B are driven with the solenoid valves 232 and 242 closed and the solenoid valves 271 and 272 opened to generate a pressure difference, the liquid can be circulated from the supply tank 210, via the liquid path 281, the filter 261, the deaerator 260, the first manifold 230, the manifold connection path 270, the second manifold 240, and the liquid path 282, to the collection tank 220 in response to the pressure difference.

The liquid level detector 211, 221, and 291 in the respective tanks are not limited to any particular detector, and can employ, for example, a float type detection method, a detection method using a two or more electrode pins for detecting a voltage, or a liquid level detection method using a laser to detect the presence or absence of the liquid.

The supply tank 210, the collection tank 220, and the sub tank 290 are provided with the solenoid valves 212, 222, and 292, respectively, as air release mechanisms. The solenoid valve enables air inside the tank to communicate with the atmosphere.

The liquid circulation device 200 includes an air supply-and-exhaust system that adjusts the internal pressure of the supply tank 210 and the collection tank 220. The air supply-and-exhaust system includes a gas storage unit (supply-side air tank) connected to the supply tank 210 and a gas storage unit (collection-side air tank) connected to the collection tank 220.

The air supply-and-exhaust system further includes a supply-side air path 83 (i.e., a first gas path) that connects the supply tank 210 and the supply-side air tank, a supply-side air pump 81 (i.e., a first gas pump) disposed in the supply-side air path 83 to pressurize (or depressurize in some cases) the supply tank 210, a collection-side air path 84 (i.e., a second gas path) that connects the collection tank 220 and the collection-side air tank, and a collection-side air pump 82 (i.e., a second gas pump) disposed in the collection-side air path 84 to depressurize the collection tank 220. The supply-side air pump 81 may depressurize the supply tank 210 to a negative pressure lower than that of the collection tank 220.

The functions of the gas space 210a of the supply tank 210 and the gas space 220a of the collection tank 220 will be described below. In the gas space 210a and the gas space 220a, the surface of the liquid is in contact with a gas (e.g., air or inert gas).

When a pressurized state (positive pressure) of the gas is generated in the supply tank 210 and a depressurized state (negative pressure) of the gas is generated in the collection tank 220, it can be said the supply tank 210 and the collection tank 220 store the positive pressure and the negative pressure, respectively, due to the compressibility of the gas. In this case, the gas is considered to be similar to a capacitor component when being expressed by an equivalent electric circuit, and can also be expressed as compliance (elastic component).

When the liquid feed pumps 202 (i.e., the first liquid feed pump 202A and the second liquid feed pump 202B), which are disposed in the liquid paths 203 (i.e., the first liquid path 203A and the second liquid path 203B) communicating with the supply tank 210 and the collection tank 220, are driven, a pressure change (pulsation) is generated. When the pressure change propagates to the meniscus of the liquid in the nozzle 104 through the liquid path 203, the liquid may overflow or may entrain bubbles. The compliance (elastic component) can reduce such a pressure change. A typical gas has compressibility and can serve as the compliance (elastic component). Accordingly, the gas space 210a and the gas space 220a can reduce a large pressure change.

Further, the liquid circulation device 200 includes a bypass 90 (i.e., a gas bypass) communicating with the gas space 210a and the gas space 220a. The bypass 90 can reduce the pulsation of the liquid generated when the liquid is fed from the collection tank 220 to the supply tank 210.

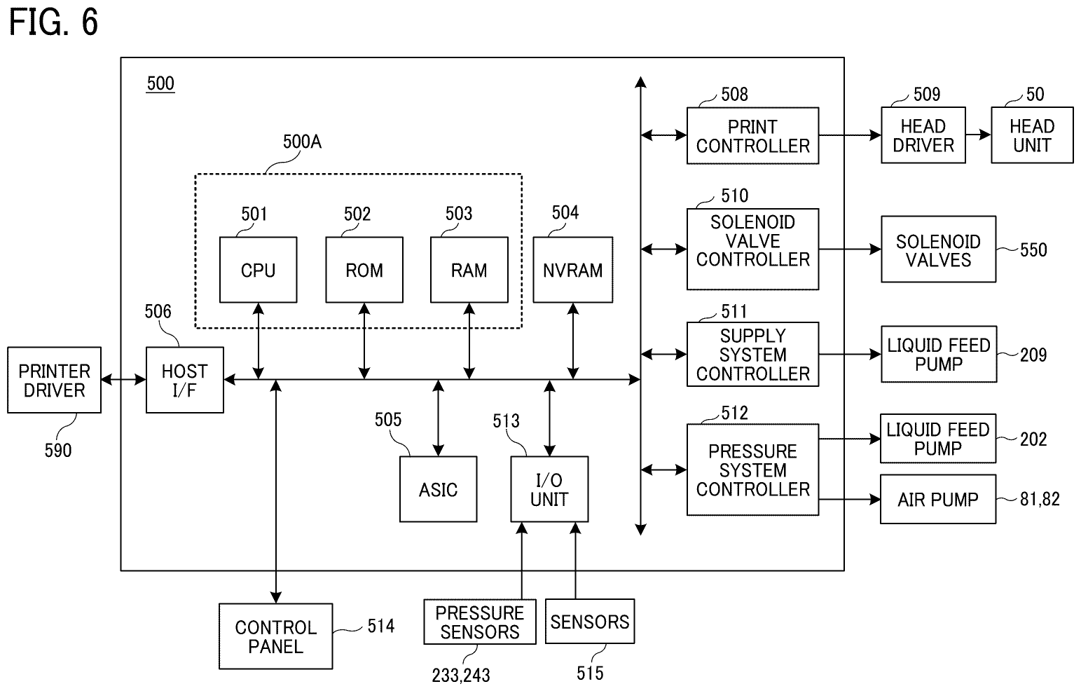

A controller of the liquid discharge apparatus (the printer 1000) is described below with reference to FIG. 6. FIG. 6 is a functional block diagram of the controller.

In FIG. 6, a controller 500 as circuitry includes a main controller 500A that includes a central processing unit (CPU) 501, a read-only memory (ROM) 502, and a random-access memory (RAM) 503. The CPU 501 administrates the control of the entire liquid discharge apparatus. The ROM 502 stores fixed data, such as various programs including programs executed by the CPU 501. The RAM 503 temporarily stores image data and other data.

The controller 500 further includes a nonvolatile RAM (NVRAM) 504 that is rewritable and retains data while the apparatus is powered off. The controller 500 further includes an application-specific integrated circuit (ASIC) 505 that performs image processing, such as various signal processing and sorting on image data, and processing of input and output signals for other control. The controller 500 transmits and receives data to and from a printer driver 590 via a host interface (I/F) 506.

The controller 500 further includes a print controller 508 including a data transfer unit, a drive signal generation unit, and a bias voltage output unit for controlling a head driver 509 to drive each head 100 of the head unit 50. The head driver 509 is a drive integrated circuit (IC) for driving each head 100.

The controller 500 further includes a solenoid valve controller 510 that controls the driving of the solenoid valves 232, 242, 271, and 272 and the solenoid valves 212, 222, 292, 287, and 288 in a group of solenoid valves 550.

The controller 500 further includes a supply system controller 511 that controls the driving of the third liquid feed pump 209. The controller 500 further includes a pressure system controller 512 that controls the driving of the first liquid feed pump 202A, the second liquid feed pump 202B, the supply-side air pump 81, and the collection-side air pump 82 to control (change) flow rates of liquid and gas. The first liquid feed pump 202A and the second liquid feed pump 202B may be referred to collectively as a liquid feed pump 202 unless distinguished from each other in the following description.

The controller 500 further includes an input/output (I/O) unit 513. The I/O unit 513 can perform the processing of data from sensors to acquire data from various sensors 515 and detection results by the pressure sensors 233 and 243. The I/O unit 513 extracts data for controlling the liquid discharge apparatus, and the print controller 508, the solenoid valve controller 510, the supply system controller 511, and the pressure system controller 512 use the data to control the respective components. The controller 500 is connected to a control panel 514 to input and display data for the liquid discharge apparatus.

### Configuration of Part of Liquid Circulation Device

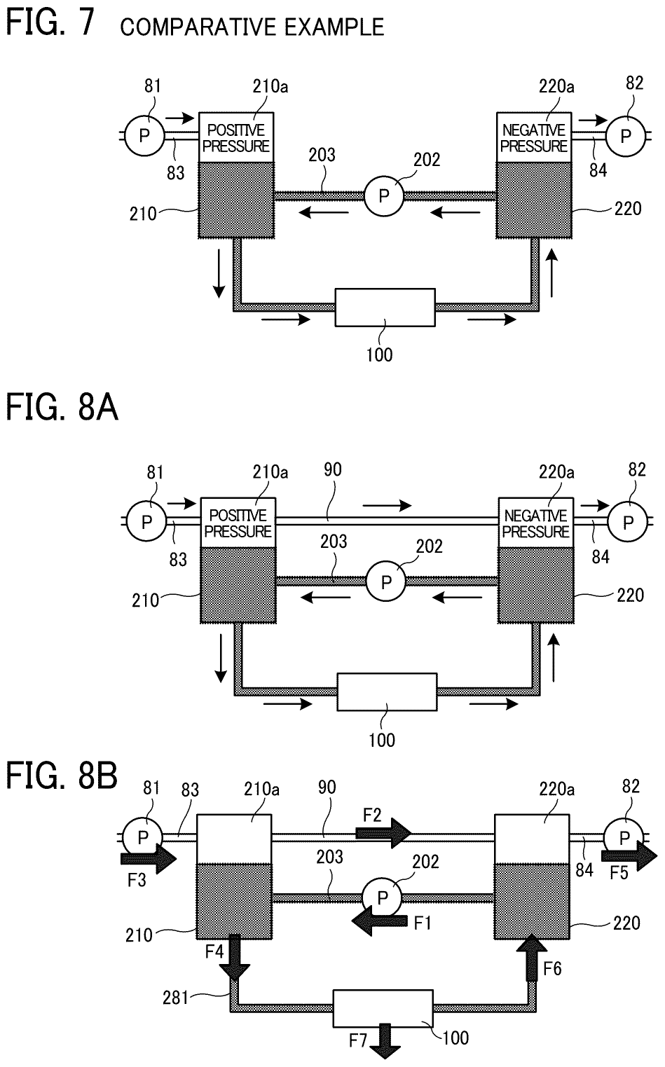

FIG. 7 is a schematic diagram illustrating a configuration of a part of a liquid circulation device according to a comparative example. In the liquid circulation device of FIG. 7, the supply tank 210, the collection tank 220, and the head 100 form a liquid circulation system to discharge liquid from the head 100 while circulating the liquid. In the liquid circulation system, the liquid is fed to the head 100 by a pressure difference between the supply tank 210 and the collection tank 220. The liquid feed pump 202 is disposed in the liquid path 203 to feed the liquid from the collection tank 220 to the supply tank 210.

When the liquid is supplied toward the head 100 and the liquid in the supply tank 210 decreases, the volume of the gas space 210a of the supply tank 210 increases and the internal pressure of the supply tank 210 decreases. The supply-side air pump 81 is operated to supply gas to the supply tank 210 to adjust the internal pressure of the supply tank 210.

On the other hand, when the liquid is collected into the collection tank 220 and the liquid in the collection tank 220 increases, the volume of the gas space 220a of the collection tank 220 decreases and the internal pressure of the collection tank 220 increases. The collection-side air pump 82 is operated to suck (vacuum) the gas in the collection tank 220 to adjust the internal pressure of the collection tank 220.

When the liquid in the supply tank 210 decreases and the liquid in the collection tank 220 increases, the liquid feed pump 202 feeds the liquid from the collection tank 220 to the supply tank 210.

When the liquid is supplied to the supply tank 210 and the liquid in the supply tank 210 increases, the volume of the gas space 210a of the supply tank 210 decreases and the internal pressure of the supply tank 210 increases. On the other hand, when the liquid in the collection tank 220 decreases, the volume of the gas space 220a of the collection tank 220 increases and the internal pressure of the collection tank 220 decreases.

At this time, even if the supply-side air pump 81 is operated, the internal pressure of the supply tank 210 does not decrease, and the pulsation of the pressure may be generated until the internal pressure decreases due to the decrease in the amount of liquid. Similarly, the internal pressure of the collection tank 220 does not increase even if the collection-side air pump 82 is operated, and the pulsation of the pressure may be generated until the internal pressure increases due to the increase in the amount of liquid.

In the present embodiment, the liquid circulation device 200 includes the bypass 90 that prevents the pulsation of the pressure described above. A description is given below of a liquid circulation device according to an embodiment of the present disclosure.

### First Embodiment

FIGS. 8A and 8B are schematic diagrams each illustrating a configuration of a part of a liquid circulation device according to a first embodiment of the present disclosure. Arrows in FIGS. 8A and 8B indicate the direction of flow of liquid and gas.

The liquid circulation device of the present embodiment includes the supply tank 210 and the collection tank 220 to store a liquid, the head 100 to discharge the liquid, the path to circulate the liquid via the head 100, the liquid feed pump 202 disposed in the liquid path 203 to feed the liquid from the collection tank 220 to the supply tank 210, the supply-side air pump 81 disposed in the supply-side air path 83 communicating with the gas space 210a of the supply tank 210, the collection-side air pump 82 disposed in the collection-side air path 84 communicating with the gas space 220a of the collection tank 220, and the bypass 90 connecting the gas space 210a of the supply tank 210 and the gas space 220a of the collection tank 220 and serving as the flow path for gas flowing from the supply tank 210 to the collection tank 220. The flow rate of the gas flowing through the bypass 90 is smaller than the maximum flow rate of the liquid flowing through the liquid feed pump 202.

As illustrated in FIG. 8B, when a second flow rate F2 represents the flow rate of the gas flowing through the bypass 90 and a first flow rate F1 represents the flow rate of the liquid flowing through the liquid feed pump 202, the liquid circulation device of the present embodiment satisfies the relationship of F1_{MAX}>F2.

The “flow rate” is the amount of movement of liquid or gas per unit time, and the “maximum flow rate” is the maximum flow rate of liquid or gas at which the pump can supply the liquid or the gas.

The bypass 90 allows gas to flow from the supply tank 210 to the collection tank 220. Thus, even when the liquid feed pump 202 is operated and the liquid in the supply tank 210 increases, the gas in the gas space 210a is exhausted through the bypass 90. Accordingly, the increase in the internal pressure of the supply tank 210 is prevented, and the pulsation of the pressure is reduced.

Further, even when the liquid feed pump 202 is operated and the liquid in the collection tank 220 decreases, the gas is supplied to the gas space 220a through the bypass 90. Accordingly, the decrease in the internal pressure of the collection tank 220 is prevented, and the pulsation of the pressure is reduced.

On the other hand, when the liquid feed pump 202 is not operated, the feeding of the liquid is stopped and the internal pressure of the supply tank 210 decreases, but the supply-side air pump 81 is operated to supply the gas to the supply tank 210 to adjust the internal pressure of the supply tank 210. Further, although the internal pressure of the collection tank 220 increases, the collection-side air pump 82 is operated to suck (vacuum) the gas in the collection tank 220 to adjust the internal pressure of the collection tank 22.

Since the second flow rate F2 of the gas flowing through the bypass 90 is smaller than the maximum value of the first flow rate F1 of the liquid flowing through the liquid feed pump 202, the fluctuation of the internal pressure of the supply tank 210 and the collection tank 220 does not exceed the range of the fluctuation of the internal pressure due to the operation of the liquid feed pump 202.

With the configuration of the present embodiment, the internal pressure of the supply tank 210 and the collection tank 220 can be easily adjusted within a certain range, and the pulsation of the pressure can be reduced with a simple configuration.

### Flow Rate of Supply-Side Air Pump

In the liquid circulation device of the present embodiment, the maximum flow rate of the gas flowing through the supply-side air pump 81 is preferably larger than the flow rate of the gas flowing through the bypass 90.

As illustrated in FIG. 8B, when the second flow rate F2 represents the flow rate of the gas flowing through the bypass 90 and a third flow rate F3 represents the flow rate of the gas flowing through the supply-side air pump 81, the liquid circulation device of the present embodiment preferably satisfies the relationship of F3_{MAX}>F2.

With such a configuration, the fluctuation of the internal pressure of the supply tank 210 due to the gas flowing out through the bypass 90 does not exceed the range of the fluctuation of the internal pressure due to the operation of the supply-side air pump 81. Accordingly, the internal pressure of the supply tank 210 can be easily adjusted within a certain range.

The flow rate of the gas flowing through the supply-side air pump 81 is preferably larger than the sum of the flow rate of the gas flowing through the bypass 90 and the flow rate of the liquid supplied from the supply tank 210 to the head 100.

As illustrated in FIG. 8B, when the third flow rate F3 represents the flow rate of the gas flowing through the supply-side air pump 81, the second flow rate F2 represents the flow rate of the gas flowing through the bypass 90, and a fourth flow rate F4 represents the flow rate of the liquid supplied from the supply tank 210 to the head 100, the liquid circulation device of the present embodiment preferably satisfies the relationship of F3>(F2+F4).

With such a configuration, the internal pressure of the supply tank 210 can be easily adjusted within a certain range in consideration of the fluctuation of the internal pressure (the decrease in the internal pressure) of the supply tank 210 due to the circulation of the liquid.

The flow rate of the gas flowing through the supply-side air pump 81 is preferably larger than the sum of the flow rate of the gas flowing through the bypass 90 and the flow rate of the liquid supplied from the supply tank 210 to the head 100, which is increased by the amount of the liquid that has been discharged from the head 100.

As illustrated in FIG. 8B, when the third flow rate F3 represents the flow rate of the gas flowing through the supply-side air pump 81, the second flow rate F2 represents the flow rate of the gas flowing through the bypass 90, the fourth flow rate F4 represents the flow rate of the liquid supplied from the supply tank 210 to the head 100, and a seventh flow rate F7 represents the flow rate of the liquid that has been discharged from the head 100, the liquid circulation device of the present embodiment preferably satisfies the relationship of F3>(F2+F4+F7).

With such a configuration, the internal pressure of the supply tank 210 can be reliably adjusted within a certain range in consideration of the fluctuation of the internal pressure (the decrease in the internal pressure) of the supply tank 210 due to the amount of the liquid discharged from the head 100.

### Flow Rate of Collection-Side Air Pump

In the liquid circulation device of the present embodiment, the maximum flow rate of the gas flowing through the collection-side air pump 82 is preferably larger than the flow rate of the gas flowing through the bypass 90.

As illustrated in FIG. 8B, when the second flow rate F2 represents the flow rate of the gas flowing through the bypass 90 and a fifth flow rate F5 represents the flow rate of the gas flowing through the collection-side air pump 82, the liquid circulation device of the present embodiment preferably satisfies the relationship of F5_{MAX}>F2.

With such a configuration, the fluctuation of the internal pressure of the collection tank 220 due to the gas flowing into the collection tank 220 through the bypass 90 does not exceed the range of the fluctuation of the internal pressure due to the operation of the collection-side air pump 82. Accordingly, the internal pressure of the collection tank 220 can be easily adjusted within a certain range.

The flow rate of the gas flowing through the collection-side air pump 82 is preferably larger than the sum of the flow rate of the gas flowing through the bypass 90 and the flow rate of the liquid collected into the collection tank 220 via the head 100.

As illustrated in FIG. 8B, when the fifth flow rate F5 represents the flow rate of the gas flowing through the collection-side air pump 82, the second flow rate F2 represents the flow rate of the gas flowing through the bypass 90, and a sixth flow rate F6 represents the flow rate of the liquid collected into the collection tank 220, the liquid circulation device of the present embodiment preferably satisfies the relationship of F5>(F2+F6).

With such a configuration, the internal pressure of the collection tank 220 can be easily adjusted within a certain range in consideration of the fluctuation of the internal pressure (the increase in the internal pressure) of the collection tank 220 due to the circulation of the liquid.

The flow rate of the gas flowing through the collection-side air pump 82 is preferably larger than the sum of the flow rate of the gas flowing through the bypass 90 and the flow rate of the liquid collected into the collection tank 220 via the head 100, which is decreased by the amount of the liquid that has been discharged from the head 100.

As illustrated in FIG. 8B, when the fifth flow rate F5 represents the flow rate of the gas flowing through the collection-side air pump 82, the second flow rate F2 represents the flow rate of the gas flowing through the bypass 90, the sixth flow rate F6 represents the flow rate of the liquid collected into the collection tank 220, and the seventh flow rate F7 represents the flow rate of the liquid that has been discharged from the head 100, the liquid circulation device of the present embodiment preferably satisfies the relationship of F5>(F2+F6−F7).

With such a configuration, the internal pressure of the collection tank 220 can be adjusted in accordance with the presence and absence of the liquid discharge from the head 100 within a certain range in consideration of the fluctuation of the internal pressure of the collection tank 220 due to the amount of the liquid discharged from the head 100.

### Second Embodiment

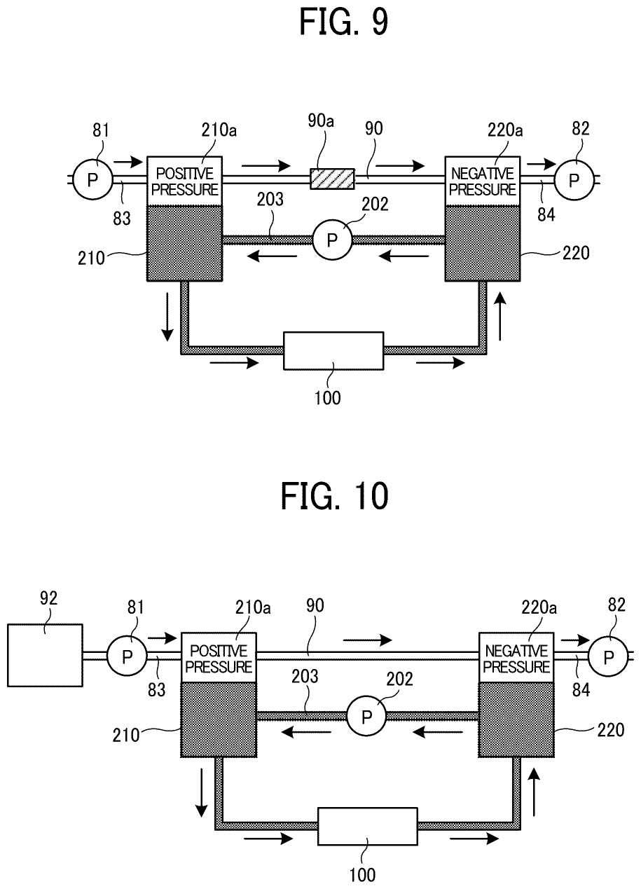

FIG. 9 is a schematic diagram illustrating a configuration of a part of a liquid circulation device according to a second embodiment of the present disclosure. Arrows in FIG. 9 indicate the direction of flow of liquid or gas.

The liquid circulation device of the present embodiment includes a variable restrictor 90a (i.e., a flow rate regulator) that can change the flow rate of the gas flowing through the bypass 90.

The variable restrictor 90a is not limited to any particular restrictor as long as the restrictor has a resistance to the liquid flowing through the bypass 90 and can change the flow rate of the liquid. Preferably, the restrictor 90a can change the resistance in response to an environmental temperature. In the liquid circulation device of the present embodiment, the flow rate of the gas flowing through the bypass 90 changes in response to the environmental temperature.

Examples of the liquid discharged from the head 100 include a liquid, such as ink, whose viscosity changes in response to the temperature. In such a liquid, the viscosity decreases and the flow rate of the circulating liquid increases in a high-temperature environment, and the viscosity increases and the flow rate of the circulating liquid decreases in a low-temperature environment.

For this reason, the flow rate of the gas flowing through the bypass 90 can preferably be adjusted in accordance with the change in the flow rate of the liquid depending on the environmental temperature. For example, the bypass 90 has a cross-sectional area that changes in response to the environmental temperature in a part of the path to change the flow rate of the gas flowing through the bypass 90.

Further, the bypass 90 may include an environmental temperature detector to detect the environmental temperature and the flow rate regulator to regulate the flow rate of the gas in response to the environmental temperature detected by the environmental temperature detector.

### Third Embodiment

FIG. 10 is a schematic diagram illustrating a configuration of a part of a liquid circulation device according to a third embodiment of the present disclosure. Arrows in FIG. 10 indicate the direction of flow of liquid or gas.

The liquid circulation device of the present embodiment includes a buffer tank 92 to store an inert gas. The buffer tank 92 communicates with the supply-side air path 83 to supply the inert gas to the gas space 210a of the supply tank 210 via the supply-side air pump 81.

Examples of the inert gas stored in the buffer tank 92 include nitrogen, but are not limited thereto as long as the inert gas can prevent the circulating liquid from changing in quality (deteriorating).

Such a configuration can prevent the deterioration (degeneration) of the liquid stored in the supply tank 210 due to oxygen or carbon dioxide in the air. Further, the inert gas fed to the collection tank 220 through the bypass 90 can prevent the deterioration of the circulating liquid and the increase in the amount of dissolved oxygen. Accordingly, the liquid can be stably discharged by the head 100.

### Fourth Embodiment

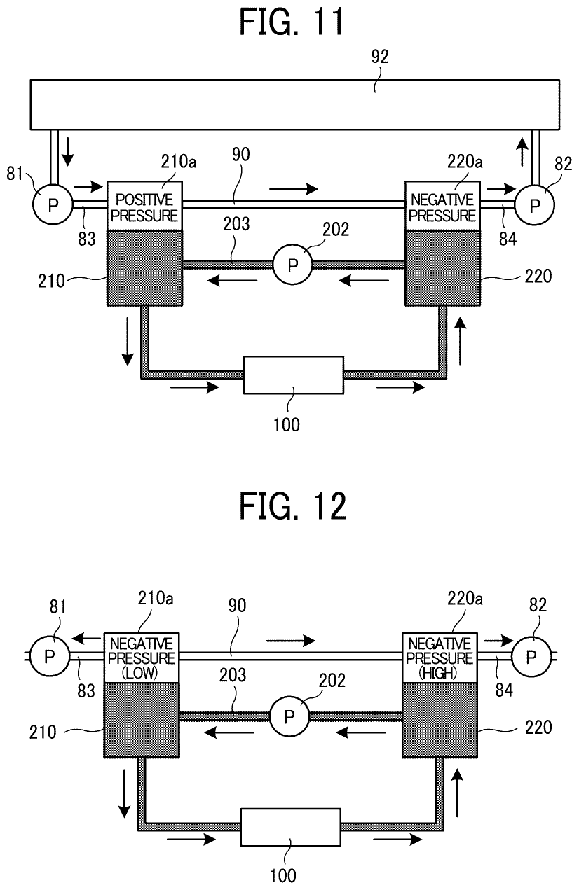

FIG. 11 is a schematic diagram illustrating a configuration of a part of a liquid circulation device according to a fourth embodiment of the present disclosure. Arrows in FIG. 11 indicate the direction of flow of liquid or gas.

The liquid circulation device of the present embodiment includes the buffer tank 92 to store an inert gas, and the buffer tank 92 communicates with the supply-side air path 83 and the collection-side air path 84.

The inert gas supplied to the gas space 210a of the supply tank 210 via the supply-side air pump 81 is supplied to the collection tank 220 via the bypass 90, and the inert gas supplied to the collection tank 220 is collected to the buffer tank 92 via the collection-side air pump 82.

Similarly to the third embodiment, such a configuration can prevent the deterioration of the circulating liquid and the increase in the amount of dissolved oxygen. As a result, the head 100 can stably discharge the liquid. Further, since the inert gas is circulated via the buffer tank 92, the amount of use (consumption) of the inert gas can be reduced.

### Fifth Embodiment

FIG. 12 is a schematic diagram illustrating a configuration of a part of a liquid circulation device according to a fifth embodiment of the present disclosure.

In the liquid circulation device of the present embodiment, the supply-side air pump 81 applies a negative pressure to the supply tank 210, and the internal pressure of the supply tank 210 is set to a negative pressure lower than that of the collection tank 220. Specifically, the absolute value of the negative pressure in the supply tank 210 is smaller than the absolute value of the negative pressure in the collection tank 220.

The circulation of the liquid via the head 100 is performed by feeding the liquid based on the pressure difference between the supply tank 210 and the collection tank 220. When the pressure difference applied to the head 100 is small, the internal pressure of the supply tank 210 may be set to a negative pressure as well as the collection tank 220, as in the present embodiment.

The head 100 is a circulation-type liquid discharge head. In the circulation-type liquid discharge head, the liquid is supplied from the supply tank 210 to the head 100 through the inlet (i.e., the supply port 171), and the liquid that has not been discharged from the head 100 is collected to the collection tank 220 through the outlet (i.e., the delivery port 181).

For example, the circulation-type liquid discharge head may be an individual liquid chamber type head in which liquid circulates in the vicinity of nozzles or a head in which liquid circulates only in a common liquid chamber. However, when the pressure difference between the supply tank 210 and the collection tank 220 is small as in the present embodiment, a circulation-type liquid discharge head in which liquid circulates only in a common liquid chamber is preferable.

### Liquid Circulation Method

A liquid circulation method of the present embodiment is a method including making the flow rate of the gas flowing through the bypass 90 smaller than the maximum liquid flow rate of the liquid flowing through the liquid feed pump 202 in the liquid circulation device 200. The liquid circulation device 200 includes the supply tank 210 and the collection tank 220 to store a liquid, the head 100 to discharge the liquid, the path to circulate the liquid via the head 100, the liquid feed pump 202 disposed in the liquid path 203 to feed the liquid from the collection tank 220 to the supply tank 210, the supply-side air pump 81 disposed in the supply-side air path 83 communicating with the gas space 210a of the supply tank 210, the collection-side air pump 82 disposed in the collection-side air path 84 communicating with the gas space 220a of the collection tank 220, and the bypass 90 connecting the gas space 210a of the supply tank 210 and the gas space 220a of the collection tank 220 and serving as the flow path for the gas flowing from the supply tank 210 to the collection tank 220.

The liquid circulation method of the present embodiment further includes controlling the maximum flow rate of the gas flowing through the supply-side air pump 81 to be larger than the flow rate of the gas flowing through the bypass 90.

The flow rate of the gas flowing through the supply-side air pump 81 is preferably made larger than the sum of the flow rate of the gas flowing through the bypass 90 and the flow rate of the liquid supplied from the supply tank 210 to the head 100.

The flow rate of the gas flowing through the supply-side air pump 81 is preferably made larger than the sum of the flow rate of the gas flowing through the bypass 90 and the flow rate of the liquid supplied from the supply tank 210 to the head 100, which is increased by the amount of the liquid that has been discharged from the head 100.

The liquid circulation method of the present embodiment further includes controlling the maximum flow rate of the gas flowing through the collection-side air pump 82 to be larger than the flow rate of the gas flowing through the bypass 90.

The flow rate of the gas flowing through the collection-side air pump 82 is preferably made larger than the sum of the flow rate of the gas flowing through the bypass 90 and the flow rate of the liquid collected into the collection tank 220 via the head 100.

The flow rate of the gas flowing through the collection-side air pump 82 is preferably made larger than the sum of the flow rate of the gas flowing through the bypass 90 and the flow rate of the liquid collected into the collection tank 220 via the head 100, which is decreased by the amount of the liquid that has been discharged from the head 100.

In the liquid circulation method of the present embodiment, the flow rate of the gas flowing through the bypass is preferably controlled in accordance with the environmental temperature.

The liquid circulation device including a buffer tank that stores an inert gas preferably supplies the inert gas to the gas space 210a of the supply tank 210 via the supply-side air pump 81.

In the present disclosure, the term “liquid discharge apparatus” includes a liquid discharge head and drives the liquid discharge head to discharge liquid, and is not limited to the printer 1000 illustrated in FIG. 1.

In the present disclosure, the liquid is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

In the “liquid discharge head,” examples of an energy source for generating energy to discharge liquid include a piezoelectric actuator (a laminated piezoelectric element or a thin-film piezoelectric element), a thermal actuator that employs a thermoelectric transducer element, such as a thermal resistor, and an electrostatic actuator including a diaphragm and opposed electrodes.

The term “liquid discharge apparatus” used herein represents an apparatus that drives the liquid discharge head to discharge liquid. The term “liquid discharge apparatus” used herein includes, in addition to apparatuses to discharge liquid to a medium onto which liquid can adhere, apparatuses to discharge the liquid into gas (air) or a different liquid.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

The term “liquid discharge apparatus” may be an apparatus in which the liquid discharge head and the medium onto which liquid can adhere move relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The terms “image formation,” “recording,” “printing,” “image printing,” and “fabricating” used herein may be used synonymously with each other.

Aspects of the present disclosure are, for example, as follows.

### Aspect 1

A liquid circulation device includes a supply tank and a collection tank to store a liquid, a head to discharge the liquid, a path to circulate the liquid via the head, a liquid feed pump disposed in a liquid path to feed the liquid from the collection tank to the supply tank, a supply-side air pump disposed in a supply-side air path communicating with a gas space of the supply tank, a collection-side air pump disposed in a collection-side air path communicating with a gas space of the collection tank, and a bypass connecting the gas space of the supply tank and the gas space of the collection tank and serving as the flow path for gas flowing from the supply tank to the collection tank. The flow rate of the gas flowing through the bypass is smaller than the maximum flow rate of the liquid flowing through the liquid feed pump.

In other words, a liquid circulation device includes a supply tank to store a liquid to be supplied to a head and a gas in a first space above a surface of the liquid in the supply tank, a collection tank to store the liquid collected from the head and the gas in a second space above a surface of the liquid in the collection tank, a circulation path including a first circulation path connecting the supply tank and an inlet of the head and a second circulation path connecting an outlet of the head and the collection tank to circulate the liquid through the head, a liquid path connecting the supply tank and the collection tank, a liquid feed pump to feed the liquid from the collection tank to the supply tank through the liquid path, a first gas path communicating with the first space in the supply tank, a first gas pump to supply gas to the first space through the first gas path, a second gas path communicating with the second space in the collection tank, a second gas pump to vacuum the gas from the collection tank through the second gas path, a gas bypass connecting the first space in the supply tank and the second space in the collection tank, and circuitry to control the liquid feed pump to flow the liquid through the liquid path at a first flow rate and control the first gas pump and the second gas pump to flow the gas from the first space to the second space through the gas bypass at a second flow rate smaller than a maximum value of the first flow rate.

### Aspect 2

In the liquid circulation device according to Aspect 1, a maximum flow rate of the gas flowing through the supply-side air pump is larger than the flow rate of the gas flowing through the bypass.

In other words, the circuitry is further configured to control the first gas pump to supply the gas to the supply tank at a third flow rate, a maximum value of which is larger than the second flow rate.

### Aspect 3

In the liquid circulation device according to Aspect 1 or 2, a flow rate of the gas flowing through the supply-side air pump is larger than a sum of the flow rate of the gas flowing through the bypass and a flow rate of the liquid supplied from the supply tank to the head.

In other words, the circuitry is further controls the first gas pump to supply the gas to the supply tank at a third flow rate, controls the first gas pump and the liquid feed pump to supply the liquid from the supply tank to the head through the first circulation path at a fourth flow rate, and controls the first gas pump to control the third flow rate to be larger than a sum of the second flow rate and the fourth flow rate.

### Aspect 4

In the liquid circulation device according to any one of Aspects 1 to 3, a flow rate of the gas flowing through the supply-side air pump is larger than a sum of the flow rate of the gas flowing through the bypass and a flow rate of the liquid supplied from the supply tank to the head, which is increased by the amount of the liquid that has been discharged from the head.

In other words, in the liquid discharge apparatus according to Aspect 14, the circuitry controls the first gas pump to supply the gas to the supply tank at a third flow rate, controls the first gas pump and the liquid feed pump to supply the liquid from the supply tank to the head through the first circulation path at a fourth flow rate, and controls the first gas pump to control the third flow rate to be larger than a sum of the second flow rate and the fourth flow rate. The fourth flow rate is increased by a seventh flow rate of the liquid that has been discharged from the head.

### Aspect 5

In the liquid circulation device according to any one of Aspects 1 to 4, a maximum flow rate of the gas flowing through the collection-side air pump is larger than the flow rate of the gas flowing through the bypass.

In other words, the circuitry is further configured to control the second gas pump to vacuum the gas from the collection tank at a fifth flow rate, a maximum value of which is larger than the second flow rate.

### Aspect 6

In the liquid circulation device according to any one of Aspects 1 to 5, a flow rate of the gas flowing through the collection-side air pump is larger than a sum of the flow rate of the gas flowing through the bypass and a flow rate of the liquid collected into the collection tank via the head.

In other words, the circuitry controls the second gas pump to vacuum the gas from the collection tank at a fifth flow rate, controls the second gas pump and the liquid feed pump to collect the liquid from the head to the collection tank through the second circulation path at a sixth flow rate, and controls the second gas pump to control the fifth flow rate to be larger than a sum of the second flow rate and the sixth flow rate.

### Aspect 7

In the liquid circulation device according to any one of Aspects 1 to 6, a flow rate of the gas flowing through the collection-side air pump is larger than a sum of the flow rate of the gas flowing through the bypass and a flow rate of the liquid collected into the collection tank via the head, which is decreased by the amount of the liquid that has been discharged from the head.

In other words, in the liquid discharge apparatus according to Aspect 14, the circuitry controls the second gas pump to vacuum the gas from the collection tank at a fifth flow rate, controls the second gas pump and the liquid feed pump to collect the liquid from the head to the collection tank through the second circulation path at a sixth flow rate, and controls the second gas pump to control the fifth flow rate to be larger than a sum of the second flow rate and the sixth flow rate. The sixth flow rate is decreased by a seventh flow rate of the liquid that has been discharged from the head.

### Aspect 8

In the liquid circulation device according to any one of Aspects 1 to 7, the flow rate of the gas flowing through the bypass changes in response to an environmental temperature.

In other words, the circuitry further configured to change the second flow rate in response to an environmental temperature.

### Aspect 9

In the liquid circulation device according to Aspect 8, the bypass has a flow path whose cross-sectional area changes in response to the environmental temperature.

In other words, the circuitry changes a cross-sectional area of the gas bypass in response to the environmental temperature.

### Aspect 10

In the liquid circulation device according to Aspect 8, the bypass includes an environmental temperature detector and a unit that controls a flow rate of the gas in accordance with a detection result of the environmental temperature detector.

In other words, the gas bypass includes an environmental temperature detector to detect the environmental temperature and a flow rate regulator to regulate the second flow rate. The circuitry controls the flow rate regulator to change the second flow rate in response to the environmental temperature detected by the environmental temperature detector.

### Aspect 11

The liquid circulation device according to any one of Aspects 1 to 10, further includes a buffer tank to store an inert gas. The buffer tank communicates with the supply-side air path. The inert gas is supplied to the gas space of the supply tank via the supply-side air pump.

In other words, the liquid circulation device according to any one of Aspects 1 to 10, further includes a buffer tank to store an inert gas. The buffer tank communicates with the first gas path, and the first gas pump supplies the inert gas to the first space in the supply tank through the first gas path.

### Aspect 12

In the liquid circulation device according to Aspect 11, the buffer tank communicates with the supply-side air path and the collection-side air path. The inert gas supplied to the supply tank is supplied to the collection tank via the bypass. The inert gas supplied to the collection tank is collected into the buffer tank via the collection-side air pump.

In other words, the buffer tank further communicates with the second gas path. The inert gas supplied to the supply tank is supplied to the collection tank via the gas bypass. The second gas pump collects the inert gas from the collection tank to the buffer tank through the second gas path.

### Aspect 13

In the liquid circulation device according to any one of Aspects 1 to 12, the head is a circulation-type liquid discharge head.

In other words, in the liquid discharge apparatus according to Aspect 14, the liquid is supplied from the supply tank to the head through the inlet, and the liquid that has not been discharged from the head is collected to the collection tank through the outlet.

### Aspect 14

A liquid discharge apparatus includes the liquid circulation device according to any one of Aspects 1 to 13.

In other words, a liquid discharge apparatus includes the liquid circulation device according to any one of Aspects 1 to 13 and a head having the inlet connected to the first circulation path and the outlet connected to the second circulation path to discharge the liquid.

### Aspect 15

An image forming apparatus includes the liquid circulation device according to any one of Aspects 1 to 13.

In other words, an image forming apparatus includes the liquid circulation device according to any one of Aspects 1 to 13, a head having the inlet connected to the first circulation path and the outlet connected to the second circulation path to discharge the liquid onto a medium, and a conveyor to convey the medium to the head.

### Aspect 16

A liquid discharge apparatus includes a head to discharge a liquid, a supply tank to store the liquid and a gas, a collection tank to store the liquid and the gas, and a circulation path to circulate the liquid. The circulation path includes a first circulation path connecting the supply tank and the head and a second circulation path connecting the head and the collection tank. The liquid discharge head further includes a liquid path connecting the supply tank and the collection tank, a liquid feed pump to feed the liquid from the collection tank to the supply tank through the liquid path, a first gas pump to supply gas to the supply tank, a second gas pump to vacuum the gas from the collection tank, and a gas bypass connecting the supply tank and the collection tank.

### Aspect 17

In the liquid discharge apparatus according to Aspect 16, further includes circuitry that controls the liquid feed pump to flow the liquid through the liquid path at a first flow rate and controls the first gas pump and the second gas pump to flow the gas from the supply tank to the collection tank through the gas bypass at a second flow rate smaller than a maximum value of the first flow rate.

Aspect 18 In the liquid discharge apparatus according to Aspect 16 or 17, the gas in the supply tank is in a first space above a surface of the liquid in the supply tank, and the gas in the collection tank is in a second space above a surface of the liquid in the collection tank. The gas bypass connects the first space and the second space.

### Aspect 19

An image forming apparatus includes a head to discharge a liquid onto a medium, a supply tank to store the liquid and a gas, a collection tank to store the liquid and the gas, and a circulation path to circulate the liquid. The circulation path includes a first circulation path connecting the supply tank and the head and a second circulation path connecting the head and the collection tank. The image forming apparatus further include a liquid path connecting the supply tank and the collection tank, a liquid feed pump to feed the liquid from the collection tank to the supply tank through the liquid path, a first gas pump to supply gas to the supply tank, a second gas pump to vacuum the gas from the collection tank, a gas bypass connecting the supply tank and the collection tank, and circuitry that controls the liquid feed pump to flow the liquid through the liquid path at a first flow rate and controls the first gas pump and the second gas pump to flow the gas from the supply tank to the collection tank through the gas bypass at a second flow rate smaller than a maximum value of the first flow rate.

### Aspect 20

The image forming apparatus according to Aspect 19, further comprising a conveyor to convey the medium.

### Aspect 21

A liquid circulation method includes making a flow rate of a gas flowing through a bypass smaller than a maximum liquid flow rate of a liquid flowing through a liquid feed pump in the liquid circulation device. The liquid circulation device includes a supply tank and a collection tank to store the liquid, a head to discharge the liquid, a path to circulate the liquid via the head, the liquid feed pump disposed in a liquid path to feed the liquid from the collection tank to the supply tank, a supply-side air pump disposed in a supply-side air path communicating with a gas space of the supply tank, a collection-side air pump disposed in a collection-side air path communicating with a gas space of the collection tank, and the bypass connecting the gas space of the supply tank and the gas space of the collection tank and serving as the flow path for the gas flowing from the supply tank to the collection tank.

As described above, according to one aspect of the present disclosure, a liquid circulation device can be provided that reduces, with a simple configuration, the pulsation of pressure that is generated when a pump is driven to feed the liquid from the collection tank to the supply tank.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A liquid circulation device comprising:
a supply tank to store a liquid to be supplied to a head and a gas in a first space above a surface of the liquid in the supply tank;
a collection tank to store the liquid collected from the head and the gas in a second space above a surface of the liquid in the collection tank;
a circulation path to circulate the liquid through the head, the circulation path including:
a first circulation path connecting the supply tank and an inlet of the head; and
a second circulation path connecting an outlet of the head and the collection tank;
a liquid path connecting the supply tank and the collection tank;
a liquid feed pump to feed the liquid from the collection tank to the supply tank through the liquid path;
a first gas path communicating with the first space in the supply tank;
a first gas pump to supply gas to the first space through the first gas path;
a second gas path communicating with the second space in the collection tank;
a second gas pump to vacuum the gas from the collection tank through the second gas path;
a gas bypass connecting the first space in the supply tank and the second space in the collection tank; and
circuitry configured to:
control the liquid feed pump to flow the liquid through the liquid path at a first flow rate; and
control the first gas pump and the second gas pump to flow the gas from the first space to the second space through the gas bypass at a second flow rate smaller than a maximum value of the first flow rate.

2. The liquid circulation device according to claim 1,
wherein the circuitry is further configured to control the first gas pump to supply the gas to the supply tank at a third flow rate, a maximum value of which is larger than the second flow rate.

3. The liquid circulation device according to claim 1,
wherein the circuitry is further configured to:
control the first gas pump to supply the gas to the supply tank at a third flow rate;
control the first gas pump and the liquid feed pump to supply the liquid from the supply tank to the head through the first circulation path at a fourth flow rate; and
control the first gas pump to control the third flow rate to be larger than a sum of the second flow rate and the fourth flow rate.

4. The liquid circulation device according to claim 1,
wherein the circuitry is further configured to control the second gas pump to vacuum the gas from the collection tank at a fifth flow rate, a maximum value of which is larger than the second flow rate.

5. The liquid circulation device according to claim 1,
wherein the circuitry is further configured to:
control the second gas pump to vacuum the gas from the collection tank at a fifth flow rate;
control the second gas pump and the liquid feed pump to collect the liquid from the head to the collection tank through the second circulation path at a sixth flow rate; and
control the second gas pump to control the fifth flow rate to be larger than a sum of the second flow rate and the sixth flow rate.

6. The liquid circulation device according to claim 1,
wherein the circuitry further configured to change the second flow rate in response to an environmental temperature.

7. The liquid circulation device according to claim 6,
wherein the circuitry further configured to change a cross-sectional area of the gas bypass in response to the environmental temperature.

8. The liquid circulation device according to claim 6,
wherein the gas bypass includes:
an environmental temperature detector to detect the environmental temperature; and
a flow rate regulator to regulate the second flow rate; and
the circuitry further configured to control the flow rate regulator to change the second flow rate in response to the environmental temperature detected by the environmental temperature detector.

9. The liquid circulation device according to claim 1, further comprising a buffer tank to store an inert gas,
wherein the buffer tank communicates with the first gas path, and
the first gas pump supplies the inert gas to the first space in the supply tank through the first gas path.

10. The liquid circulation device according to claim 9,
wherein the buffer tank further communicates with the second gas path,
the inert gas supplied to the supply tank is supplied to the collection tank via the gas bypass, and
the second gas pump collects the inert gas from the collection tank to the buffer tank through the second gas path.

11. A liquid discharge apparatus comprising:
the liquid circulation device according to claim 1; and
a head having the inlet connected to the first circulation path and the outlet connected to the second circulation path to discharge the liquid.

12. The liquid discharge apparatus according to claim 11,
wherein the liquid is supplied from the supply tank to the head through the inlet, and
the liquid that has not been discharged from the head is collected to the collection tank through the outlet.

13. The liquid discharge apparatus according to claim 11,
wherein the circuitry is further configured to:
control the first gas pump to supply the gas to the supply tank at a third flow rate;
control the first gas pump and the liquid feed pump to supply the liquid from the supply tank to the head through the first circulation path at a fourth flow rate; and
control the first gas pump to control the third flow rate to be larger than a sum of the second flow rate and the fourth flow rate, the fourth flow rate increased by a seventh flow rate of the liquid that has been discharged from the head.

14. The liquid discharge apparatus according to claim 11,
wherein the circuitry is further configured to:
control the second gas pump to vacuum the gas from the collection tank at a fifth flow rate;
control the second gas pump and the liquid feed pump to collect the liquid from the head to the collection tank through the second circulation path at a sixth flow rate; and
control the second gas pump to control the fifth flow rate to be larger than a sum of the second flow rate and the sixth flow rate, the sixth flow rate decreased by a seventh flow rate of the liquid that has been discharged from the head.

15. An image forming apparatus comprising:
the liquid circulation device according to claim 1;
a head having the inlet connected to the first circulation path and the outlet connected to the second circulation path to discharge the liquid onto a medium; and
a conveyor to convey the medium to the head.

16. A liquid discharge apparatus comprising:
a head to discharge a liquid;
a supply tank to store the liquid and a gas;
a collection tank to store the liquid and the gas;
a circulation path to circulate the liquid, the circulation path including:
a first circulation path connecting the supply tank and the head; and
a second circulation path connecting the head and the collection tank;
a liquid path connecting the supply tank and the collection tank;
a liquid feed pump to feed the liquid from the collection tank to the supply tank through the liquid path;
a first gas pump to supply gas to the supply tank;
a second gas pump to vacuum the gas from the collection tank; and
a gas bypass connecting the supply tank and the collection tank.

17. The liquid discharge apparatus according to claim 16, further comprising circuitry configured to:
control the liquid feed pump to flow the liquid through the liquid path at a first flow rate; and
control the first gas pump and the second gas pump to flow the gas from the supply tank to the collection tank through the gas bypass at a second flow rate smaller than a maximum value of the first flow rate.

18. The liquid discharge apparatus according to claim 16,
wherein the gas in the supply tank is in a first space above a surface of the liquid in the supply tank,
the gas in the collection tank is in a second space above a surface of the liquid in the collection tank, and
the gas bypass connecting the first space and the second space.

19. An image forming apparatus comprising:
a head to discharge a liquid onto a medium;
a supply tank to store the liquid and a gas;
a collection tank to store the liquid and the gas;
a circulation path to circulate the liquid, the circulation path including:
a first circulation path connecting the supply tank and the head; and
a second circulation path connecting the head and the collection tank;
a liquid path connecting the supply tank and the collection tank;
a liquid feed pump to feed the liquid from the collection tank to the supply tank through the liquid path;
a first gas pump to supply gas to the supply tank;
a second gas pump to vacuum the gas from the collection tank;
a gas bypass connecting the supply tank and the collection tank; and
circuitry configured to:
control the liquid feed pump to flow the liquid through the liquid path at a first flow rate; and
control the first gas pump and the second gas pump to flow the gas from the supply tank to the collection tank through the gas bypass at a second flow rate smaller than a maximum value of the first flow rate.

20. The image forming apparatus according to claim 19, further comprising a conveyor to convey the medium.
